(19) United States
(12) Patent Application Publication
(10) Pub. No.: US 2007/0188310 A1
(43) Pub. Date: Aug. 16, 2007

(54) Vehicle anti-theft apparatus and method

(75) Inventors: Kazunori Mori, Tokyo (JP); Izumi Tsutsui, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI ELECTRIC CORPORATION

(21) Appl. No.: 11/489,604

(22) Filed: Jul. 20, 2006

(30) Foreign Application Priority Data
Feb. 13, 2006 (JP) 2006-035311

(51) Int. Cl. B60R 25/10

(52) U.S. Cl. 340/426.36

(57) ABSTRACT

A vehicle anti-theft apparatus and method can prevent the theft of a vehicle without increasing costs, and hence the illegal use of the theft vehicle. The apparatus includes a smart key carried by a user, and a smart keyless control device installed on the vehicle. The smart key includes a storage section for storing identification information and use time limit information of the vehicle. The smart keyless control device reads the identification information and the use time limit information stored in a memory, and authenticates the vehicle user based on the identification information and the use time limit information upon use of the vehicle. The use of the vehicle is permitted when the identification information and the authentication identification information set beforehand in the smart keyless control device coincide with each other, and when a current time is within a use time limit of the use time limit information.

### BACKGROUND OF THE INVENTION

1. Field of the Invention

The present invention relates to a vehicle anti-theft apparatus and method in which a smart key and a smart keyless control device are provided for preventing the theft of a vehicle.

2. Description of the Related Art

There has hitherto been known a vehicle anti-theft apparatus which includes a portable transmitter comprising a memory for storing individual identification IDs, a CPU for converting the individual identification IDs in the memory into corresponding data signals for radio transmission, and a transmitter part for transmitting the data signals from the CPU through radio communications, a receiver comprising a receiver part that receives the data signals from the portable transmitter and a CPU that compares the individual identification IDs of the thus received signals with the individual collation identification IDs stored in the memory and outputs only coincident or matched signals to an engine control section, and an engine control section comprising a CPU that manages the operating environment of the engine and performs the management of a vehicle security mechanism.

When the data signals are sent from the portable transmitter to the receiver, the receiver makes comparison between the individual identification IDs and the individual collation identification IDs, and outputs only the coincident signal to the engine control section thereby to put it into an engine start stand-by state (for example, first patent document: Japanese utility model application laid-open No. H06-74537).

In addition, there has hitherto been known a rental car system which includes at least one keyless remote controller transmitter to which individual ID information is given and which sends a predetermined unlock signal containing at least ID information in accordance with an unlock operation, at least one vehicle having a keyless remote controller receiver which collates, upon reception of the predetermined unlock signal containing ID information, the ID information contained in the unlock signal to the use permission ID information that has been beforehand registered and set by a vehicle management center through a radio communication section, and unlocks door lock if the result of the collation is a match or coincidence, and a vehicle management center that sends the ID information of a keyless remote controller transmitter held by a reserved or booked user to the keyless remote controller receiver of the vehicle to be lent through the radio communication section (for instance, see a second patent document: Japanese patent application laid-open No. 2000-13326).

In the conventional vehicle anti-theft apparatus as described in the first patent document, there is a problem that it is necessary to provide the special portable transmitter capable of communicating with the receiver, thus resulting in an increased cost.

In addition, in the conventional rental car system as described in the second patent document, there is another problem that when the ID information of the keyless remote controller transmitter is registered in the keyless remote controller receiver, it is necessary to provide the vehicle management center, thereby increasing the cost of the system. Moreover, there is a further problem that should the ID information of the keyless remote controller transmitter be deciphered and the vehicle be stolen, the theft vehicle might be illegally used.

### SUMMARY OF THE INVENTION

Accordingly, the present invention is intended to obviate the problems as referred to above, and has for its object to provide a vehicle anti-theft apparatus and method which are capable of preventing the theft of the vehicle without increasing the cost as well as the illegal use of the theft vehicle.

Bearing the above object in mind, according to the present invention, there is provided a vehicle anti-theft apparatus including a smart key that is carried by a user of a vehicle, and a smart keyless control device installed on the vehicle. The smart key includes a storage section that stores identification information of the vehicle and use time limit information of the vehicle. The smart keyless control device includes: a reading section that reads the identification information and the use time limit information stored in the storage section; and a determination section that authenticates the user based on the identification information and the use time limit information when the user uses the vehicle. When the identification information and identification information for authentication that is stored beforehand in the smart keyless control device coincide with each other, and when a current time is within a use time limit of the use time limit information, the determination section permits the use of the vehicle.

According to the vehicle anti-theft apparatus of the present invention, when the identification information of a vehicle and the identification information for authentication stored beforehand in the smart keyless control device coincide with each other, and when the current time is within the use time limit of the use time limit information of the vehicle, the determination section of the smart keyless control device permits the use of the vehicle. Accordingly, it is possible to prevent the theft of the vehicle without increasing the cost, and hence the illegal use of the theft vehicle as well.

The above and other objects, features and advantages of the present invention will become more readily apparent to those skilled in the art from the following detailed description of a preferred embodiment of the present invention taken in conjunction with the accompanying drawings.

### BRIEF DESCRIPTION OF THE DRAWINGS

FIG. 1 is a block diagram showing an anti-theft system of a vehicle anti-theft apparatus according to a first embodiment of the present invention.

FIG. 2 is a block diagram showing a use time limit information writing device for writing a use time limit information of a smart key according to the first embodiment of the present invention.

FIG. 3 is a flow chart illustrating a vehicle smart key generation operation of a rental car provider according to the first embodiment of the present invention.

FIG. 4 is a flow chart illustrating the operation of a smart keyless control device of the vehicle anti-theft apparatus according to the first embodiment of the present invention.

FIG. 5 is a flow chart illustrating the operation of a smart key of the vehicle anti-theft apparatus according to the first embodiment of the present invention.

FIG. 6 is a flow chart illustrating the operation of a door lock control device according to the first embodiment of the present invention.

FIG. 7 is a flow chart illustrating the operation of a steering lock control device according to the first embodiment of the present invention.

FIG. 8 is a flow chart illustrating the operation of an engine control device according to the first embodiment of the present invention.

### DESCRIPTION OF THE PREFERRED EMBODIMENT

Now, a preferred embodiment of the present invention will be described in detail while referring to the accompanying drawings. Throughout respective figures, the same or corresponding members or parts are identified by the same reference numerals and characters.

### Embodiment 1

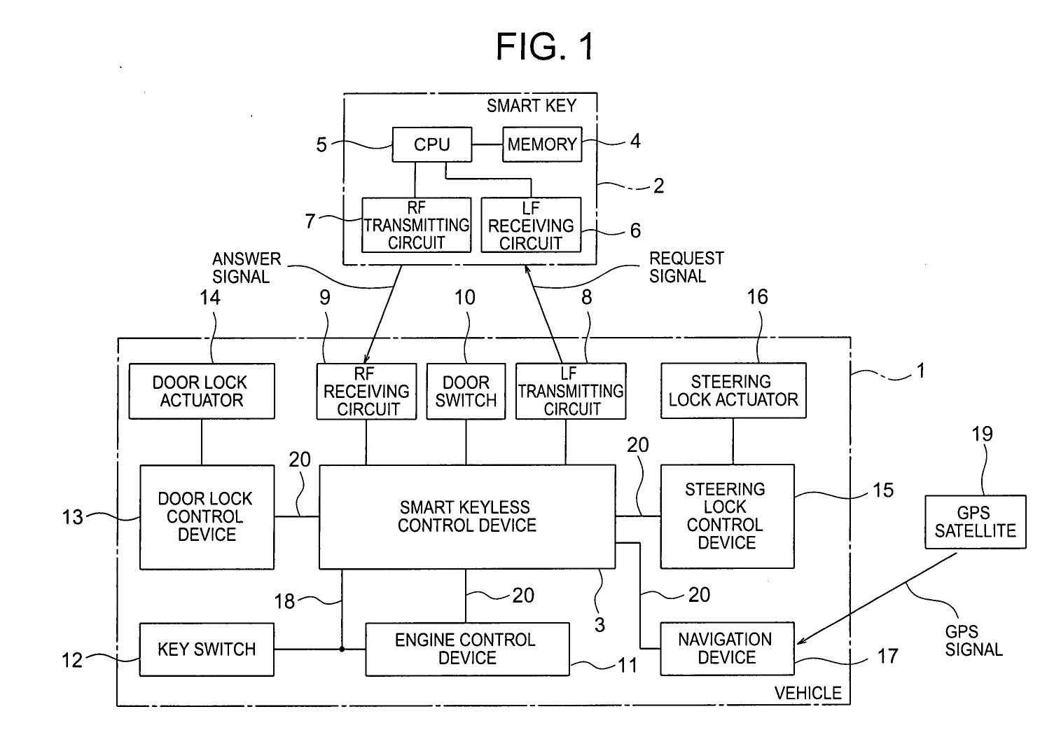

FIG. 1 is a block diagram that shows an anti-theft system of a vehicle anti-theft apparatus according to a first embodiment of the present invention.

In FIG. 1, the anti-theft system includes a smart key 2 that is carried by a user of a vehicle 1, and the vehicle 1 that has a smart keyless control device 3. Here, it is assumed that the vehicle 1 is a rental car, for example.

The smart key 2 has a memory 4 (storage section) and a CPU 5, an LF (Low Frequency) receiving circuit 6, and an RF (Radio Frequency) transmitting circuit 7.

In addition, the vehicle 1 includes the smart keyless control device 3, an LF transmitting circuit 8, an RF receiving circuit 9, a door switch 10, an engine control device 11, a key switch 12, a door lock control device 13, a door lock actuator 14, a steering lock control device 15, a steering lock actuator 16, and a navigation device 17 (GPS (Global Positioning System) device).

The memory 4 stores identification information for identifying the individual vehicle 1, and use time limit information that indicates the use time limit or expiration date and time of the vehicle 1. The identification information and the use time limit information are encrypted and rewritable.

The CPU 5 reads out identification information and use time limit information from the memory 4 in accordance with a request signal (to be described later) of an LF band radio wave received by the LF receiving circuit 6, and outputs them to the RF transmitting circuit 7. Also, in accordance with a write signal (to be described later) of an LF band radio wave received by the LF receiving circuit 6, the CPU 5 stores the use time limit information contained in a write signal into the memory 4.

The LF receiving circuit 6 receives the request signal from the LF transmitting circuit 8 of the vehicle 1 or the write signal from the use time limit information writing device 21 (to be described later), and outputs it to the CPU 5.

The RF transmitting circuit 7 sends the identification information and the use time limit information output from the CPU 5 to the RF receiving circuit 9 of the vehicle 1 as an answer signal of an RF band radio wave.

The smart keyless control device 3 requests the smart key 2 to send the identification information and the use time limit information stored in the memory 4, reads the identification information and the use time limit information from the smart key 2, and authenticates, upon the use of the vehicle 1, the user thereof based on the identification information and the use time limit information thus read.

The LF transmitting circuit 8 sends, as a request signal, a request for transmission of the identification information and the use time limit information of the smart key 2 of the smart keyless control device 3 to the LF receiving circuit 6 through a transmitting antenna (not shown).

The RF receiving circuit 9 receives the answer signal from the RF transmitting circuit 7 through a receiving antenna (not shown), and outputs it to the smart keyless control device 3.

The door switch 10 is mounted on a handle portion of each door of the vehicle 1 for detecting an unlock request for the door lock.

The engine control device 11 controls to start and stop the engine of the vehicle 1, and the key switch 12 detects an engine start request for the engine, and the key switch 12 transmits the engine start request to the smart keyless control device 3 and the engine control device 11 through a key switch signal line 18.

The door lock control device 13 controls the locking and unlocking of each door lock, and the door lock actuator 14 operates to lock and unlock each door lock.

The steering lock control device 15 controls the locking and unlocking of a steering lock, and the steering lock actuator 16 operates to lock and unlock the steering lock.

The navigation device 17 receives a GPS signal sent from a GPS satellite 19, and acquires the position information of the vehicle 1 and the current time (including the year, month, date, hour, minute and second of the present time) contained in the GPS signal. Also, the navigation device 17 outputs the current time to the smart keyless control device 3.

In addition, the engine control device 11, the door lock control device 13, the steering lock control device 15 and the navigation device 17 are connected to the smart keyless control device 3 through communication lines 20, respectively. Arbitrary communication lines such as CAN (Controller Area Network) communication lines used for in-vehicle LAN communication, ISO 14230 communication lines, dedicated serial communication line, etc., are used as the communication lines 20.

Moreover, the smart keyless control device 3 includes a reading section (not shown) that reads the identification information and the use time limit information stored in the memory 4, and a determination section (not shown) that authenticates a user of the vehicle 1 based on the identification information and the use time limit information when the vehicle 1 is used.

Here, note that the smart keyless control device 3 is composed of a microprocessor (not shown) including a CPU and a memory with programs stored therein. Also, the identification information for authentication (hereinafter referred to as authentication identification information) corresponding to the identification information of the smart key 2 is stored beforehand in the memory.

When the identification information and the authentication identification information stored in the memory coincide with each other, and when the current time input from the navigation device 17 is within the use time limit of the use time limit information, the determination section permits the use of the vehicle 1.

Here, note that the determination section performs the authentication of the user of the vehicle 1 when the user tries to release the door lock, or when the user tries to release the steering lock and start the engine.

First of all, when the determination section authenticates, upon detection of an unlock request for the door lock by the door switch 10, the user and permits the use of the vehicle 1, it outputs a door unlock enabling signal in the form of a serial communication signal to the door lock control device 13.

Also, when the determination section authenticates, upon detection of an engine start request by the key switch 12, the user and permits the use of the vehicle 1, it outputs a steering unlock enabling signal in the form of a serial communication signal to the steering lock control device 15, and at the same time outputs an engine start enabling signal in the form of a serial communication signal to the engine control device 11.

Here, note that the use time limit information of the vehicle 1 is stored beforehand in the memory 4 of the smart key 2 by the rental car provider before the user carries the smart key 2.

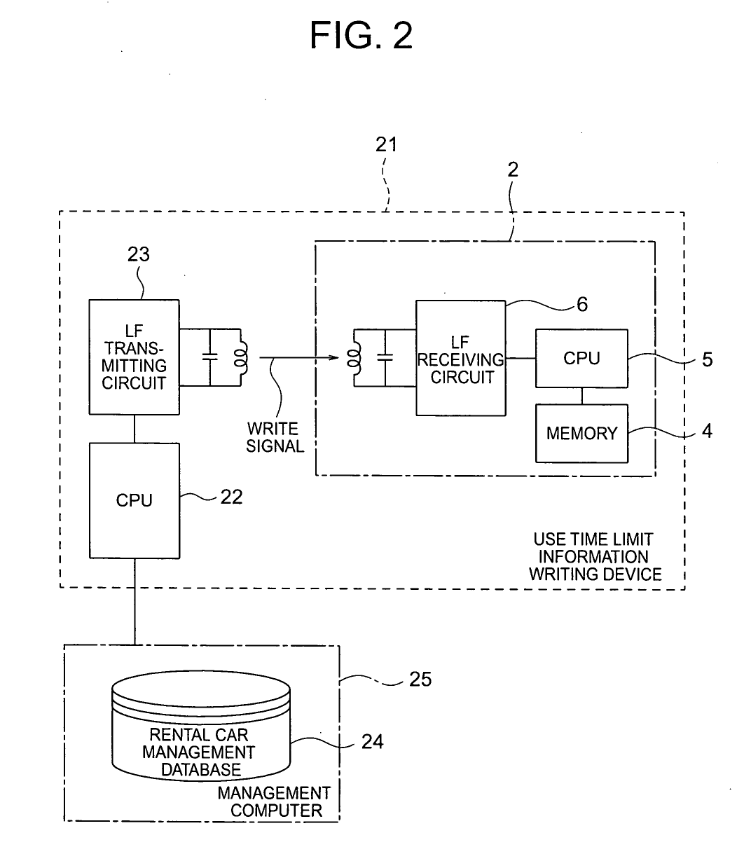

Hereinafter, reference will be made to the operation of writing the use time limit information of the smart key 2 by the rental car provider while referring to FIG. 2 together with FIG. 1.

FIG. 2 is a block diagram that shows the use time limit information writing device 21 for writing the use time limit of the smart key 2 according to the first embodiment of the present invention.

In FIG. 2, the use time limit information writing device 21 includes a CPU 22 and an LF transmitting circuit 23.

In addition, the smart key 2 is set into the use time limit information writing device 21. Here, it is assumed that the identification information of the vehicle 1 is stored beforehand in the memory 4 of the smart key 2.

The CPU 22 is connected to a management computer 25 that has a rental car management database 24. The rental car management database 24 includes the identification information and the use time limit information of the vehicle 1 that the rental car provider owns. The CPU 22 reads in use time limit information from the rental car management database 24 and outputs it to the LF transmitting circuit 23.

The LF transmitting circuit 23 outputs the use time limit information output from the CPU 22 to the LF receiving circuit 6 of the smart key 2 as a write signal.

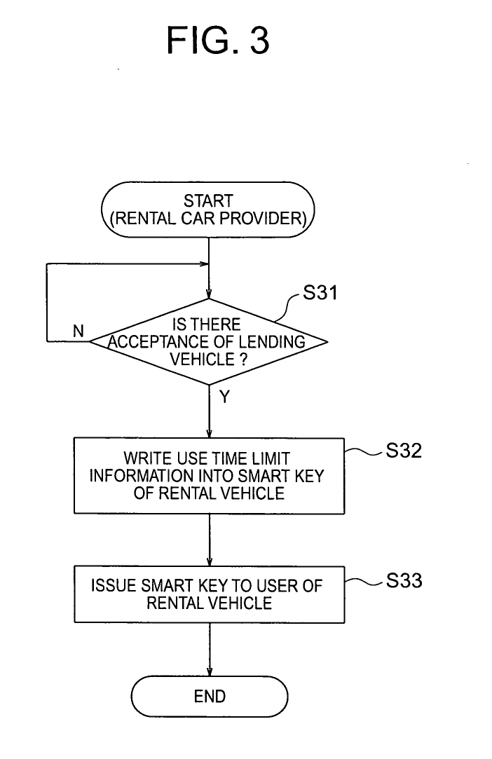

Next, reference will be made to the operation of the rental car provider issuing or generating the smart key 2 of the vehicle 1 while referring to a flow chart of FIG. 3.

First of all, the rental car provider determines whether there is the acceptance of lending the vehicle 1 (step S31).

When it is determined in step S31 that there is the acceptance of lending (that is, Yes), use time limit information is written into the smart key 2 of the vehicle 1 for rental by using the use time limit information writing device 21, as previously stated (step S32).

Subsequently, the smart key 2 is issued to the user of the rental vehicle 1 (step S33), and the flow chart of FIG. 3 is terminated.

On the other hand, when it is determined in step S31 that there is no acceptance of lending (that is, No), a return is performed to step 31 where it is determined again whether there is the acceptance of lending the vehicle 1.

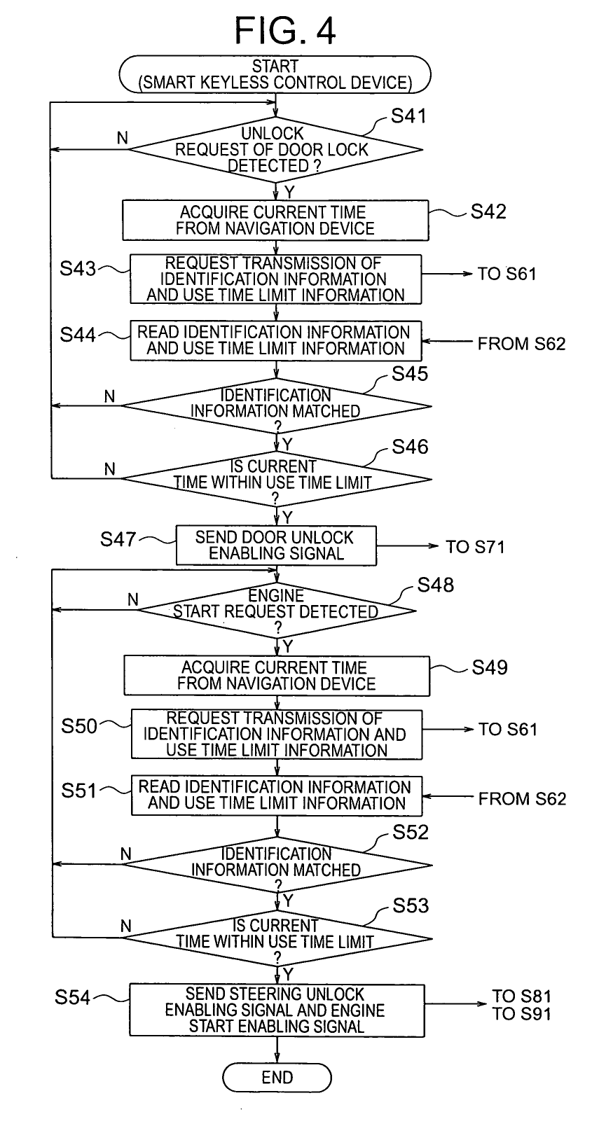

Now, reference will be made to the operation of the smart keyless control device 3 of the vehicle anti-theft apparatus according to the first embodiment of the present invention while referring to flow charts of FIG. 4 through FIG. 8.

First of all, it is determined whether an unlock request for the door lock has been detected by the door switch 10 (step S41).

When it is determined in step S41 that an unlock request for the door lock is detected (that is, Yes), the current time is acquired from the navigation device 17 (step S42).

Subsequently, a request for the transmission of the identification information and the use time limit information stored in the memory 4 is made to the smart key 2 (step S43), and the identification information and the use time limit information from the smart key 2 are read (step S44).

When the smart keyless control device 3 makes a request for the transmission of the identification information and the use time limit information to the smart key 2 in step S43, the LF transmitting circuit 8 sends a transmission request to the LF receiving circuit 6 of the smart key 2 as a request signal, and the RF receiving circuit 9 receives an answer signal and outputs it to the smart keyless control device 3.

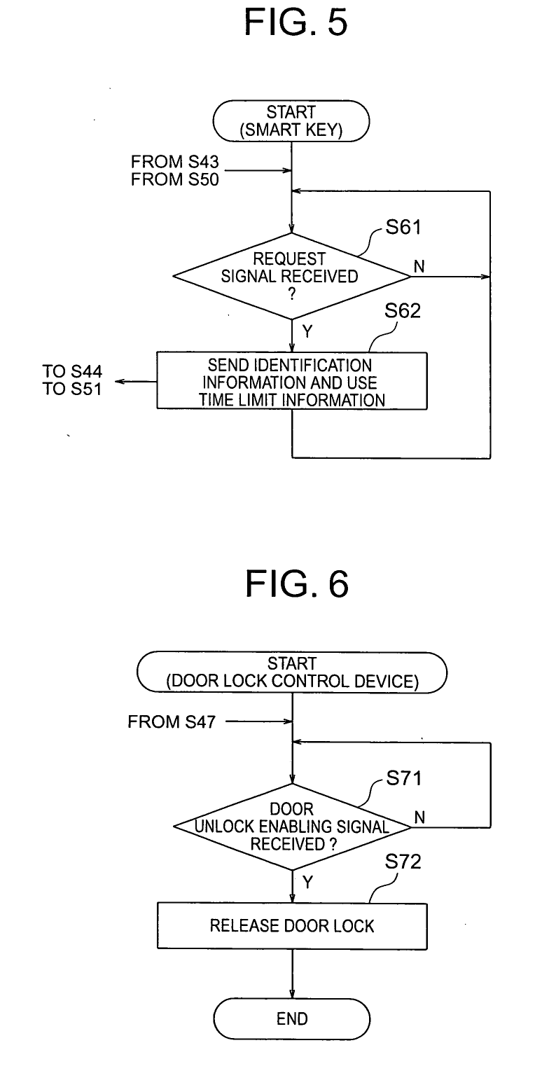

At this time, the smart key 2 executes an operation that is illustrated in a flow chart of FIG. 5.

First, the smart key 2 determines whether a request signal has been received (step S61).

When it is determined in step S61 that a request signal has been received (that is, Yes), the identification information and the use time limit information are sent to the RF receiving circuit 9 of the vehicle 1 as an answer signal (step S62), and the control flow shifts to step S61.

On the other hand, when it is determined in step S61 that no request signal has been received (that is, No), a return is performed to step 61 where it is determined again whether a request signal has been received.

Then, the determination section determines whether the identification information and the authentication identification information beforehand stored in the memory of the smart keyless control device 3 coincide with each other (step S45).

When it is determined in step S45 that the identification information and the authentication identification information coincide with each other (that is, Yes), it is further determined whether the current time is within the use time limit of the use time limit information (step S46).

When it is determined in step S46 that the current time is within the use time limit (that is, Yes), a door unlock enabling signal is output to the door lock control device 13 (step S47).

On the other hand, when it is determined in step S41 that an unlock request for the door lock has not been detected (that is, No), or when it is determined in step S45 that the identification information and the authentication identification information do not coincide with each other (that is, No), or when it is determined in step S46 that the current time is not within the use time limit (that is, No), a return is performed to step S41 where it is determined again whether an unlock request for the door lock has been detected.

At this time, the door lock control device 13 executes an operation that is illustrated in a flow chart of FIG. 6.

First, the door lock control device 13 determines whether a door unlock enabling signal has been received (step S71).

When it is determined in step S71 that a door unlock enabling signal has been received (that is, Yes), the door lock is released through the door lock actuator 14 (step S72), and the processing of FIG. 6 is terminated.

On the other hand, when it is determined in step S71 that a door unlock enabling signal has not been received (that is, No), a return is performed to step 71 where it is determined again whether a door unlock enabling signal has been received.

Then, it is determined whether an engine start request has been detected by the key switch 12 (step S48).

When it is determined in step S48 that an engine start request has been detected (that is, Yes), the current time is acquired from the navigation device 17 (step S49).

Subsequently, a request for the transmission of the identification information and the use time limit information stored in the memory 4 is made to the smart key 2 (step S50), and the identification information and the use time limit information from the smart key 2 are read (step S51).

When the smart keyless control device 3 makes a request for the transmission of the identification information and the use time limit information to the smart key 2 in step S50, the LF transmitting circuit 8 sends a request signal to the LF receiving circuit 6 of the smart key 2, and the RF receiving circuit 9 receives an answer signal and outputs it to the smart keyless control device 3, as previously stated.

At this time, the smart key 2 executes the same operation as illustrated in the flow chart of FIG. 5.

Then, the determination section determines whether the identification information and the authentication identification information beforehand stored in the memory of the smart keyless control device 3 coincide with each other (step S52).

When it is determined in step S52 that the identification information and the authentication identification information coincide with each other (that is, Yes), it is further determined whether the current time is within the use time limit of the use time limit information (step S53).

When it is determined in step S53 that the current time is within the use time limit (that is, Yes), a steering unlock enabling signal is output to the steering lock control device 15. Then, an engine start enabling signal is output to the engine control device 11 (step S54), and the processing of FIG. 4 is terminated.

On the other hand, when it is determined in step S48 that an engine start request has not been detected (that is, No), or when it is determined in step S52 that the identification information and the authentication identification information do not coincide with each other (that is, No), or when it is determined in step S53 that the current time is not within the use time limit (that is, No), a return is performed to step S48 where it is determined again whether an engine start request has been detected.

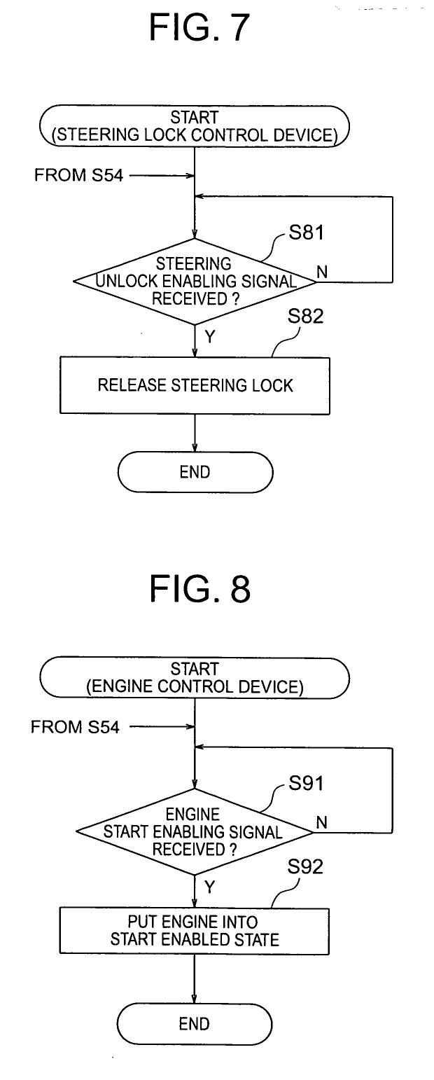

At this time, the steering lock control device 15 executes an operation that is illustrated in a flow chart of FIG. 7.

First, the steering lock control device 15 determines whether a steering unlock enabling signal has been received (step S81).

When it is determined in step S81 that a steering unlock enabling signal has been received (that is, Yes), the steering lock is released through the steering lock actuator 16 (step S82), and the processing of FIG. 7 is terminated.

On the other hand, when it is determined in step S81 that a steering unlock enabling signal has not been received (that is, No), a return is performed to step 81 where it is determined again whether a steering unlock enabling signal has been received.

At this time, the engine control device 11 executes an operation that is illustrated in a flow chart of FIG. 8.

First, the engine control device 11 determines whether an engine start enabling signal has been received (step S91).

When it is determined in step S91 that an engine start enabling signal has been received (that is, Yes), the engine is put into a startable state (step S92), and the processing of FIG. 8 is terminated.

On the other hand, when it is determined in step S91 that an engine start enabling signal has not been received (that is, No), a return is performed to step 91 where it is determined again whether an engine start enabling signal has been received.

Here, note that once the engine becomes a startable state, it holds the startable state until the power supply of the engine control device 11 is turned off, so the engine never stops during the time when the vehicle 1 is traveling.

According to the vehicle anti-theft apparatus of the first embodiment of the present invention, when the identification information and the authentication identification information stored in the memory coincide with each other, and when the current time is within the use time limit of the use time limit or rental period information, the determination section of the smart keyless control device 3 permits the use of the vehicle 1. Accordingly, it is possible to prevent the theft of the vehicle 1 without increasing the cost, and hence the illegal use of the theft vehicle.

In addition, the determination section is arranged in the interior of the smart keyless control device 3 which is difficult to illegally remodel or modify, so the theft of the vehicle 1 can be prevented.

Also, the determination section authenticates the user of the vehicle 1 at the time when the user tries to release the door lock where the release of the door lock is requested, or at the time when the user tries to release the steering lock and start the engine where the start of the engine is requested.

Thus, even when the use time limit for use or rental period expires during the vehicle 1 is traveling, the engine is not stopped suddenly, thereby making it possible to ensure proper steering.

Moreover, the current time is input from the navigation device 17 to the smart keyless control device 3, so the current time is never modified or falsified by a third party, and hence security can be improved.

Further, the use time limit or rental period information of the vehicle 1 is stored beforehand by the rental car provider by using the special or dedicated use time limit information writing device 21 before the user carries the smart key 2. In addition, the identification information and the use time limit information stored in the memory 4 are encrypted. As a result, there is no fear that the identification information and the use time limit information might be falsified by a third party, so security can be improved.

Although in the above-mentioned first embodiment, the current time is input from the navigation device 17 to the smart keyless control device 3, the present invention is not limited to this, but the current time may instead be calculated by using a timer device (not shown) built in the smart keyless control device 3 and compared with the use time limit information. Also, the standard wave having time information (current time) may be received and used as the current time. In these cases, too, the operational or advantageous effects similar to those of the above-mentioned first embodiment can be achieved.

In addition, although in the above-mentioned first embodiment, the description has been made while using the smart key 2, there may be used, in place of the smart key 2, an immobilizer key that has an immobilizer function to collate ID codes at the key side and at the vehicle side thereby to control the starting of the engine in accordance with the result of the collation. In this case, too, the operational or advantageous effects similar to those of the above-mentioned first embodiment can be achieved.

While the invention has been described in terms of a preferred embodiment, those skilled in the art will recognize that the invention can be practiced with modifications within the spirit and scope of the appended claims.

What is claimed is:

1. A vehicle anti-theft apparatus comprising a smart key that is carried by a user of a vehicle, and a smart keyless control device installed on the vehicle,
wherein the smart key includes a storage section that stores identification information of the vehicle and use time limit information of the vehicle; and
the smart keyless control device includes:
a reading section that reads the identification information and the use time limit information stored in the storage section; and
a determination section that authenticates the user based on the identification information and the use time limit information when the user uses the vehicle;
wherein when the identification information and identification information for authentication that is stored beforehand in the smart keyless control device coincide with each other, and when a current time is within a use time limit of the use time limit information, the determination section permits the use of the vehicle.

2. The vehicle anti-theft apparatus as set forth in claim 1, wherein the determination section permits the release of a door lock of the vehicle.

3. The vehicle anti-theft apparatus as set forth in claim 2, wherein the determination section authenticates the user when the user tries to release the door lock.

4. The vehicle anti-theft apparatus as set forth in claim 1, wherein the determination section permits the release of a steering lock of the vehicle and the starting of an engine of the vehicle.

5. The vehicle anti-theft apparatus as set forth in claim 4, wherein the determination section authenticates the user when the user tries to release the steering lock and start the engine.

6. The vehicle anti-theft apparatus as set forth in claim 1, wherein the current time is input from a GPS device, which is installed on the vehicle for detecting the position of the vehicle, to the smart keyless control device.

7. The vehicle anti-theft apparatus as set forth in claim 1, wherein the use time limit information is stored in advance before the user carries the smart key.

8. A vehicle anti-theft method comprising:
a step of storing, into a smart key that is carried by a user of a vehicle, identification information of the vehicle and use time limit information of the vehicle;
a step of reading the identification information and the use time limit information stored in the storage section by means of a smart keyless control device installed on the vehicle; and
a step in which the smart keyless control device permits release of a door lock of the vehicle based on the identification information and the use time limit information, when the identification information and authentication identification information stored beforehand in the smart keyless control device coincide with each other, and when a current time input from a GPS device, which is installed to the vehicle for detecting the position of the vehicle, is within a use time limit of the use time limit information.

9. A vehicle anti-theft method comprising:
a step of storing, into a smart key that is carried by a user of a vehicle, identification information of the vehicle and use time limit information of the vehicle;
a step of reading the identification information and the use time limit information stored in the storage section by means of a smart keyless control device installed on the vehicle; and
a step in which the smart keyless control device permits release of a steering lock of the vehicle and starting of an engine of the vehicle based on the identification information and the use time limit information, when the identification information and authentication identification information stored beforehand in the smart keyless control device coincide with each other, and when a current time input from a GPS device, which is installed on the vehicle for detecting the position of the vehicle, is within a use time limit of the use time limit information.
